(19) United States
(12) Patent Application Publication
(10) Pub. No.: US 2012/0086567 A1
(43) Pub. Date: Apr. 12, 2012

(54) Vehicular control system and in-vehicle apparatus

(75) Inventors: Jun Namizaki, Okazaki-city (JP); Toshifumi Shimoda, Anjo-city (JP)

(73) Assignee: DENSO CORPORATION, Kariya-city (JP)

(21) Appl. No.: 13/200,313

(22) Filed: Sep. 22, 2011

(30) Foreign Application Priority Data
Oct. 12, 2010 (JP) 2010-229501

(51) Int. Cl. B60Q 1/00

(52) U.S. Cl. 340/449

(57) ABSTRACT

An in-vehicle apparatus operates on a second frequency by a second vibrator while wirelessly receiving from a portable apparatus a wireless signal on a first frequency by a first vibrator along with information on temperature of the portable apparatus. The in-vehicle apparatus previously stores a data map of a frequency and temperature characteristic of the first vibrator and second vibrator while measuring own temperature. The in-vehicle apparatus has an amendment device that acquires an offset value for the second vibrator based on the data map and information on temperatures of the in-vehicle apparatus and portable terminal. The acquired offset value is added to the second vibrator to thereby cause the second frequency to approach the first frequency of the first vibrator.

### CROSS REFERENCE TO RELATED APPLICATION

The present application is based on and incorporates herein by reference Japanese Patent Application No. 2010-229501 filed on Oct. 12, 2010.

### FIELD OF THE INVENTION

The present invention relates to a vehicular control system to communicate between a portable apparatus and an in-vehicle apparatus, and the in-vehicle apparatus.

### BACKGROUND OF THE INVENTION

[Patent document 1] JP-H5-156851 A

There is conventionally known a keyless entry system or smart entry system to lock and unlock a door of a vehicle without need of a user inserting a key into a key cylinder (for example, refer to Patent document 1).

In the keyless entry system, a user manipulates a button in a key of a portable apparatus to thereby transmit a wireless signal; upon receiving the wireless signal, an in-vehicle apparatus locks or unlocks a door of a vehicle.

In contrast, in the smart entry system, an in-vehicle apparatus (smart ECU) mounted in a vehicle transmits a request signal; a smart key (portable apparatus) transmits a response signal in response to the request signal. The in-vehicle apparatus collates the received response signal and unlocks and locks a door of the vehicle based on the collation result.

In these systems, the portable apparatuses and the in-vehicle apparatuses individually contain vibrators to generate electric waves for wirelessly communicating between the portable apparatuses and in-vehicle apparatuses. It is noted that such a vibrator is an element that generates a fixed frequency and is a device different from an oscillator such as a temperature compensation crystal oscillator (TCXO) in which a frequency change due to temperature is reduced by a temperature compensation circuit.

In contrast, the oscillator has a frequency and temperature characteristic of oscillating on frequencies according to temperatures; when the temperature of the oscillator changes, the oscillating frequency of the oscillator changes. That is, the oscillator has frequencies deviated due to temperatures.

For example, when using a crystal as a vibrator, the crystal has a frequency and temperature characteristic that varies with a cubic function with respect to a temperature. In addition, when using a SAW (Surface Acoustic Wave) resonator as a vibrator, the SAW resonator has a frequency and temperature characteristic that varies with a quadratic function with respect to a temperature.

Under such a circumstance, the in-vehicle apparatus needs to receive any wireless signal transmitted from the portable apparatus. In contrast, the vibrator contained in the in-vehicle apparatus has a frequency drift due to temperature; the in-vehicle apparatus needs to have a filter with a frequency band to cover a reception frequency having a drift due to temperature. When the frequency band of the filter is thus broadened, the in-vehicle apparatus has a tendency to receive interferences (that is, noises), which poses a problem of adversely affecting sensitivity and resistance to noise.

### SUMMARY OF THE INVENTION

The present invention takes the above problem into consideration. It is an object of the present invention to reduce a frequency drift due to temperature with respect to a vibrator used in an in-vehicle apparatus to wirelessly communicate with a portable apparatus.

To achieve the above object, according to a first aspect of the present invention, an in-vehicle apparatus mounted in a vehicle is provided as follows. The in-vehicle apparatus wirelessly communicates with a portable apparatus carried by a user. The portable apparatus drives a first vibrator that oscillates on a first frequency to generate a wireless signal on the first frequency while transmitting the wireless signal containing transmission side temperature information that indicates a temperature of the portable apparatus. The in-vehicle apparatus controls a permission or refusal of a manipulation of the user to the in-vehicle apparatus upon receiving the wireless signal from the portable apparatus. The in-vehicle apparatus includes: a second vibrator to oscillate on a second frequency; a second temperature sensor to measure a temperature of the in-vehicle apparatus; a reception IC to drive the second vibrator to generate a basic signal on the second frequency, operating based on the basic signal while receiving the wireless signal containing the transmission side temperature information; and an amendment device. The amendment device stores a data map of a frequency and temperature characteristic with respect to the first vibrator and the second vibrator, receives the transmission side temperature information via the reception IC and reception side temperature information which indicates the temperature of the in-vehicle apparatus from the second temperature sensor, acquires an offset value based on the transmission side temperature information, the reception side temperature information, and the data map, and executes an amendment to cause the second frequency of the second vibrator to approach the first frequency of the first vibrator by adding the acquired offset value to the second vibrator.

Thus, the offset value is added to the second vibrator based on the transmission side temperature information, reception side temperature information, and data map. Therefore, the oscillating frequency of the second vibrator can be adjusted finely such that the second frequency of the second vibrator approaches the first frequency of the portable apparatus. This configuration can reduce the frequency drift due to temperature with respect to the second frequency of the vibrator used for the in-vehicle apparatus.

According to a second aspect of the present invention, a vehicular control system is provided as follows. The system includes a portable apparatus carried by a user and an in-vehicle apparatus mounted in a vehicle, for controlling a permission or refusal of a manipulation of the user to the in-vehicle apparatus based on wireless communications of the portable apparatus and the in-vehicle apparatus. The portable apparatus includes: a first vibrator to oscillate on a first frequency; a first temperature sensor to measure a temperature of the portable apparatus; and a transmission IC to drive the first vibrator and generate a wireless signal on the first frequency while transmitting the wireless signal containing transmission side temperature information which indicates a temperature of the portable apparatus measured by the first temperature sensor. The in-vehicle apparatus includes: a second vibrator to oscillate on a second frequency; a second temperature sensor to measure a temperature of the in-vehicle apparatus; a reception IC to drive the second vibrator to generate a basic signal on the second frequency, operating based on the basic signal while receiving the wireless signal containing the transmission side temperature information; and an amendment device. The amendment device stores a data map of a frequency and temperature characteristic with respect to the first vibrator and the second vibrator, receives the transmission side temperature information via the reception IC and reception side temperature information which indicates the temperature of the in-vehicle apparatus from the second temperature sensor, acquires an offset value based on the transmission side temperature information, the reception side temperature information, and the data map, and executes an amendment to cause the second frequency of the second vibrator to approach the first frequency of the first vibrator by adding the acquired offset value to the second vibrator.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram of a vehicular control system according to an embodiment of the present invention;

FIG. 2 is a diagram illustrating an example of a frequency and temperature characteristic of a first vibrator used for a portable apparatus; and

FIG. 3 is a diagram illustrating an example of a frequency and temperature characteristic of a second vibrator used for an in-vehicle apparatus.

### DETAILED DESCRIPTION OF THE PREFERRED EMBODIMENTS

An embodiment of the present invention is explained with reference to drawings. A vehicular control system according to an embodiment of the present embodiment is to control a permission or refusal of a user's manipulation to an in-vehicle apparatus based on a wireless communication between the in-vehicle apparatus and a portable apparatus. A smart entry system is explained as an example of the vehicular control system. In such a case, the in-vehicle apparatus is an apparatus to lock and unlock a door of a vehicle.

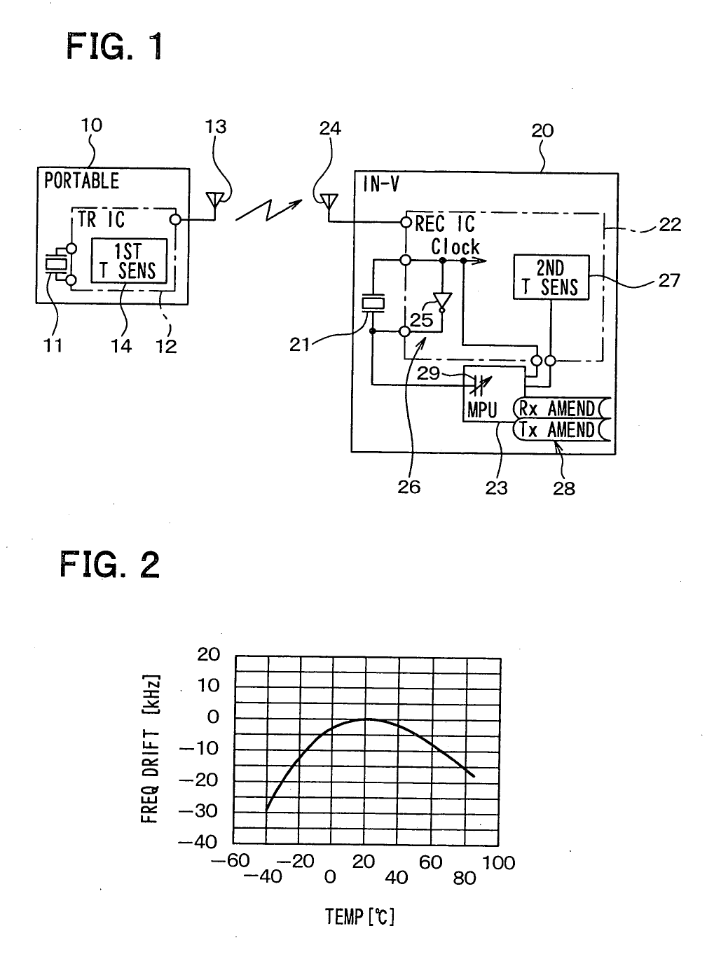

FIG. 1 is a block diagram of the vehicular control system according to an embodiment of the present invention. As indicates in FIG. 1, the vehicular control system includes a portable apparatus 10 carried by a user and an in-vehicle apparatus 20 mounted in a subject vehicle.

The portable apparatus 10 is so-called a smart portable terminal for identifying the smart entry system with the in-vehicle apparatus 20 mounted in the vehicle. The user carries the portable apparatus 10 to thereby enable locking and unlocking of a door of the vehicle. Such portable apparatus 10 contains a first vibrator 11 and a transmission IC 12.

The first vibrator 11 is a vibrator that oscillates on a first frequency (for example, about 300 MHz), and is connected to the transmission IC 12. In addition, for example, the first vibrator 11 is a surface acoustic wave (SAW) resonator.

FIG. 2 illustrates a frequency and temperature characteristic of the SAW resonator. In FIG. 2, the axis of abscissa indicates a temperature and the axis of ordinates indicates a deviation or drift on frequency (i.e., a frequency deviation or drift) due to temperature on a basis of a frequency at a room temperature (near 25 degree centigrade). As illustrated, the SAW resonator has a characteristic on frequency providing a quadratic function with respect to a temperature. Therefore, as the temperature of the SAW resonator becomes higher or lower than a basis of the room temperature, the frequency drift due to temperature becomes greater while the frequency decreases.

The transmission IC 12 is to generate a wireless signal of a first frequency by driving the first vibrator 11. The wireless signal contains information on ID code for ID collation and information on permission or refusal of a user to the in-vehicle apparatus.

In addition, the transmission IC 12 contains a first temperature sensor 14 which measures a temperature of the transmission IC 12, i.e., a temperature of the portable apparatus 10. Thus, the transmission IC 12 transmits transmission side temperature information, which indicates the temperature of the portable apparatus 10 measured by the first temperature sensor 14, via the antenna 13. Here, the transmission side temperature information is contained in the wireless signal.

It is noted that the portable apparatus 10 contains a power source (unshown) and can thus always operate. In addition, the portable apparatus 10 further includes an antenna to receive a request signal for the in-vehicle apparatus 20 to request an ID code of the portable apparatus 10 and an IC which demodulates the ID code into a voltage signal.

The in-vehicle apparatus 20 communicates an ID code for identifying a smart entry system with the portable apparatus 10 and controls the locking or unlocking of a door of the vehicle. Such in-vehicle apparatus 20 contains a second vibrator 21, a reception IC 22, and an amendment device 23.

The second vibrator 21 is a vibrator that oscillates on a second frequency, and is connected with the reception IC 22. The second vibrator 21 includes a crystal.

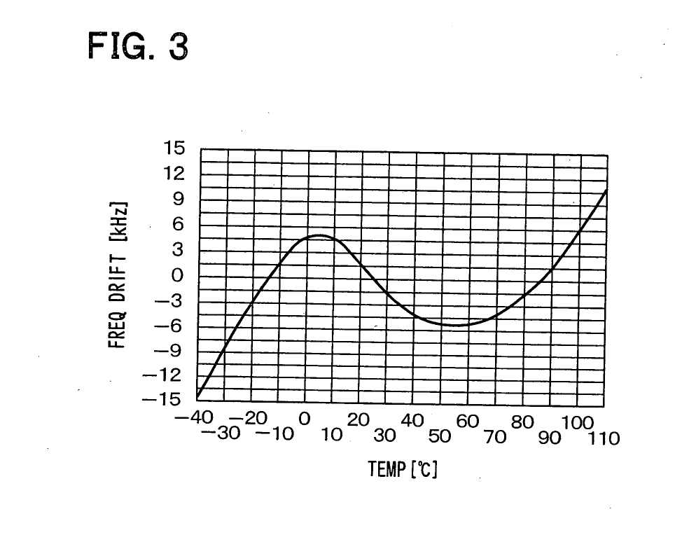

FIG. 3 illustrates a frequency temperature characteristic of the crystal. In FIG. 3, the axis of abscissa indicates a temperature and the axis of ordinates indicates a deviation or drift on frequency (i.e., a frequency deviation or drift) due to temperature on a basis of a frequency at a room temperature. As illustrated, the crystal has a characteristic on frequency providing a cubic function with respect to a temperature. Therefore, as the temperature of the crystal becomes higher than the room temperature, the frequency drift due to temperature becomes greater while the frequency increases. In contrast, the temperature of the crystal becomes lower than the room temperature, the frequency drift due to temperature becomes greater while the frequency decreases.

The reception IC 22 is to receive the wireless signal from the portable apparatus 10 via the antenna 24 in the in-vehicle apparatus 20. The reception IC 22 contains a clock generation circuit 26 having an inverter 25 and a resistance (unshown); the clock generation circuit 26 is connected with the second vibrator 21.

The reception IC 22 drives the second vibrator 21 to thereby cause the clock generation circuit 26 to generate a basic signal (Clock) on the second frequency. The clock generation circuit 26 contains a PLL circuit for applying 8 multiplying, 32 multiplying, 64 multiplying, etc. to the basic signal (Clock) on the second frequency. The reception IC 22 operates based on the basic signal generated in the PLL circuit. In addition, the reception IC 22 contains the second temperature sensor 27.

The second temperature sensor 27 measures a temperature of the reception IC 22, i.e., a temperature of the in-vehicle apparatus 20 containing the reception IC 22. The reception side temperature information acquired by the reception IC 22 is outputted to the amendment device 23. The reception IC 22 is designed to intermittently operate so that the reception temperature information is outputted to the amendment device 23 from the reception IC 22 with time intervals, e.g., every 150 ms or 250 ms. The output from the second temperature sensor 27 to the amendment device 23 is executed, for example, in a serial communication or straight line.

It is noted that the reception IC 22 contains not only the above clock generation circuit 26, the second temperature sensor 27, but also other circuits such as an amplifier, a mixer, a demodulator circuit, etc (none shown).

The amendment device 23 executes an amendment which causes the second frequency of the second vibrator 21 to approach the first frequency of the first vibrator 11. That is, the amendment device 23 amends the second frequency of the second vibrator 21 to thereby amend a frequency for electric wave communication used between the portable apparatus 10 and the in-vehicle apparatus 20. Such an amendment device 23 operates based on the basic signal (Clock) inputted from the reception IC 22. In addition, the amendment device 23 adopts a circuit device that can change a voltage such as a MPU (Micro Processing Unit) and DAC (Digital to Analog Converter). In the present embodiment, the MPU is adopted as the amendment device 23.

As mentioned above, the portable apparatus 10 is carried by the user, whereas the in-vehicle apparatus 20 is mounted in the vehicle. The temperature of the portable apparatus 10 is thus different from the temperature of the in-vehicle apparatus 20. Therefore, the first frequency of the first vibrator 11 contained in the portable apparatus 10 includes a frequency drift due to the temperature of the portable apparatus 10. Further, the second frequency of the second vibrator 21 contained in the in-vehicle apparatus 20 includes a frequency drift due to the temperature of the in-vehicle apparatus 20. Therefore, the amendment device 23 executes an amendment that causes the second frequency to approach the first frequency so as to enable the reception IC 22 to receive the wireless signal of the first frequency containing the frequency drift due to the temperature.

In specific, in order to amend the second frequency of the second vibrator 21, the amendment device 23 contains a data map (Tx amendment) on the frequency and temperature characteristic of the first vibrator 11, and a data map (Rx amendment) on the frequency and temperature characteristic of the second vibrator 21, respectively. The data maps may be stored as one data map or separately in a storage element 28 such as a ROM or flash memory built in the amendment device 23. For instance, the data maps are numerical expression maps where temperatures and frequencies in the frequency and temperature characteristics in FIGS. 2, 3 are converted into the numerical values such as the voltage values and capacitance values. Further, offset values which should be added to the second vibrator 21 is designated with respect to each of temperatures. All the frequency and temperature characteristics indicated in FIGS. 2, 3 do not need to be expressed numerically. For example, there may be provided a high-temperature data map or a low-temperature data map which expresses the characteristics only within a predetermined temperature range.

Here, “offset value” is an electrostatic capacitance; “added” signifies an increase or a decrease of an electrostatic capacitance of the second vibrator 21. Thereby, the second vibrator 21 is caused to generate the second frequency which is changed by the added offset value. That is, the frequency drift due to temperature of the second frequency of the second vibrator 21 is amended.

In addition, the amendment device 23 contains a capacitance element 29 for adding the offset value to the second vibrator 21. The capacitance element 29 is connected to the second vibrator 21. In the present embodiment, the capacitance element 29 is formed as a combination of a varicap (variable capacitance) and a capacitor array. The varicap includes a diode of which the electrostatic capacitance varies depending on a voltage applied to the terminal of the varicap, and an element which can vary the electrostatic capacitance quickly according to the applied voltage. In addition, the capacitor array is a circuit in which several sub-circuits are connected in parallel, each sub-circuit in which a switch and a capacitor are connected in series. By controlling an ON state and OFF state of each switch, a highly precise synthetic capacitance of the capacitor array is obtained.

Therefore, the data map contains an applied voltage of the varicap for realizing the “offset value” and a synthetic capacitance of the capacitor array (ON and OFF information on each switch connected to the capacitor).

Further, although none shown, the in-vehicle apparatus 20 further includes a band pass filter which passes a specific frequency selectively, a determination circuit for collating the ID code with the portable apparatus 10, and an antenna which transmits a request signal for requesting an ID code to the portable apparatus 10.

The following will explain a process by the smart entry system and an operation of the amendment device 23 of the in-vehicle apparatus 20.

First, the user approaches the vehicle while carrying the portable apparatus 10 to thereby enter a sensing area of the smart entry system. Therefore, the portable apparatus 10 receives a request signal from the in-vehicle apparatus 20, and automatically transmits a wireless signal which contains an ID code in response. Thereby, the ID code verification is executed by the in-vehicle apparatus 20. When the verification is affirmatively made (i.e., when the ID codes accord with each other), a manipulation of the locking and unlocking of a door becomes enabled. Therefore, the door is unlocked when the user grasps a door handle in the state of carrying the portable apparatus 10. The door can be locked when the user pushes a lock switch of the door.

When transmitting the wireless signal in response to the request signal, the portable apparatus 10 attaches the transmission side temperature information which indicates the temperature of the portable apparatus 10 measured by the first temperature sensor 14 to the wireless signal. Further, the transmission side temperature information may be attached to or contained in the wireless signal transmitted when the user manipulates the in-vehicle apparatus.

Further, in the in-vehicle apparatus 20, the transmission side temperature information from the portable apparatus 10 acquired by the reception IC 22 is outputted to the amendment device 23 whereas the reception side temperature information which indicates the temperature of the in-vehicle apparatus 20 measured by the second temperature sensor 27 contained in the reception IC 22 is inputted into the amendment device 23.

Therefore, the amendment device 23 acquires an offset value for adding to the second vibrator 21 from the data map of each vibrator 11, 21, based on these transmission side temperature information and reception side temperature information, so as to cause the second frequency of the second vibrator 21 to approach the first frequency of the first vibrator 11.

That is, the frequencies of the portable apparatus 10 and the in-vehicle apparatus 20 are basically designated to operate under a similar environment. In practical use, however, the portable apparatus 10 and the in-vehicle apparatus 20 may be placed under the mutually different environments. Thus the electric wave and temperature environment of the in-vehicle apparatus 20 is caused to follow the electric wave and temperature environment of the portable apparatus 10. That is, the frequency drift due to temperature of the second frequency of the second vibrator 21 is reduced in the in-vehicle apparatus 20. To that end, the amendment device 23 is provided in the in-vehicle apparatus 20. In other words, the amendment device 23 executes an amendment which causes the second frequency of the second vibrator 21 to approach the first frequency of the first vibrator 11 to thereby intend to reduce the frequency drift due to temperature of the second frequency in the in-vehicle apparatus 20.

For example, when the season is in summer, both the temperatures of the portable apparatus 10 and the in-vehicle apparatus 20 become high. Therefore, as indicated in FIG. 2, the first frequency of the first vibrator 11 mounted in the portable apparatus 10 shifts to be smaller. In contrast, as indicated in FIG. 3, the second frequency of the second vibrator 21 mounted in the in-vehicle apparatus 20 shifts to be larger. In addition, the basic signal on the second frequency undergoes multiplying in the PLL circuit of the reception IC 22; thereby, the drift of the frequency also undergoes multiplying.

Thus, the second frequency of the basic signal used by the in-vehicle apparatus 20 is deviated significantly from the first frequency by the frequency and temperature characteristics of the first vibrator 11 and the second vibrator 21, and the PLL circuit of the reception IC 22. In this regards, however, since in the in-vehicle apparatus 20, the capacitance element 29 of the amendment device 23 adds the offset value (electrostatic capacitance) at the time of the high temperature to the second vibrator 21, the second frequency serving as an oscillating frequency of the second vibrator 21 can approach the first frequency. In addition, when multiplying the second frequency in the PLL circuit of the reception IC 22, the multiplying need not be applied to the frequency drift due to temperature.

When the season is in winter, the temperature of the portable apparatus 10 carried by the user is greater than a room temperature but the temperature of the in-vehicle apparatus 20 mounted in the vehicle is similar to the temperature of the outside air. Therefore, as indicated in FIG. 2, the first frequency of the first vibrator 11 mounted in the portable apparatus 10 shifts to be smaller. In contrast, as indicated in FIG. 3, the second frequency of the second vibrator 21 mounted in the in-vehicle apparatus 20 shifts to be smaller, too. Thus, both the first frequency and the second frequency are shifted to be smaller. Even in the winter season, since in the in-vehicle apparatus 20, the capacitance element 29 of the amendment device 23 adds the offset value (electrostatic capacitance) at the time of the low temperature to the second vibrator 21, the second frequency serving as an oscillating frequency of the second vibrator 21 can approach the first frequency. In addition, as the above mentioned, the frequency drift due to temperature does not undergo the multiplying in the PLL circuit in the reception IC 22.

As explained above, in the present embodiment, the following is provided. That is, the transmission side temperature information acquired by the first temperature sensor 14 of the transmission IC 12 and the reception side temperature information acquired by the second temperature sensor 27 of the reception IC 22 are used for obtaining an offset value. The offset value is added to the capacitance element 29 so that the second frequency of the second vibrator 21 approaches the first frequency of the portable apparatus 10. Thereby, the second frequency of the second vibrator 21 can be adjusted finely. This configuration can reduce the frequency drift due to temperature with respect to the second frequency of the second vibrator 21 used for the in-vehicle apparatus 20.

In addition, amending of the electrostatic capacitance of the second vibrator 21 eliminates a need of arranging a wide-band filter in the in-vehicle apparatus 20 for the frequency drift due to temperature with respect to the second vibrator 21. The necessary minimum filter band range can be reduced. That is, there is no need of arranging the wide band for the filter of the in-vehicle apparatus 20. This configuration can help prevent the reception of the interference waves and reduction in the sensitivity and the resistance to noise.

Furthermore, there is no need of using a vibrator having a good temperature characteristic. The vibrator needs to have a specification only to cover the range that can be narrowed down by the amendment. The cheap component can be selected as the first vibrator 11 or the second vibrator 21.

### Other Embodiments

The configuration of the vehicular control system indicated in the above embodiment is only an example. Without need of limited thereto, another configuration can be adopted as long as within the scope of the present invention. The above embodiment explains the smart entry system only as an example. The present invention is also applicable to the start system which starts an ignition or keyless entry system which manipulates the open-close of the door, using the portable apparatus 10.

In addition, in the above embodiment, the combination of the varicap and the capacitor array is used for the capacitance element 29. The means to generate an offset value may be configured, for instance, by only a varicap or by only a capacitor array.

In the above embodiment, the first temperature sensor 14 is contained in the transmission IC 12 while the second temperature sensor 27 is contained in the reception IC 22. This only indicates an example of an IC which contains a temperature sensor. Therefore, the first temperature sensor 14 may be arranged in the portable apparatus 10 as an independent body separated from the transmission IC 12. Similarly, the second temperature sensor 27 may be arranged in the in-vehicle apparatus 20 as an independent body separated from the reception IC 22.

It will be obvious to those skilled in the art that various changes may be made in the above-described embodiments of the present invention. However, the scope of the present invention should be determined by the following claims.

What is claimed:

1. An in-vehicle apparatus mounted in a vehicle and wirelessly communicating with a portable apparatus carried by a user,
the portable apparatus driving a first vibrator that oscillates on a first frequency to generate a wireless signal on the first frequency while transmitting the wireless signal containing transmission side temperature information that indicates a temperature of the portable apparatus,
the in-vehicle apparatus for controlling a permission or refusal of a manipulation of the user to the in-vehicle apparatus upon receiving the wireless signal from the portable apparatus,
the in-vehicle apparatus comprising:
a second vibrator to oscillate on a second frequency;
a second temperature sensor to measure a temperature of the in-vehicle apparatus;
a reception IC to drive the second vibrator to generate a basic signal on the second frequency, operating based on the basic signal while receiving the wireless signal containing the transmission side temperature information; and
an amendment device
to store a data map of a frequency and temperature characteristic with respect to the first vibrator and the second vibrator,
to receive the transmission side temperature information via the reception IC and reception side temperature information which indicates the temperature of the in-vehicle apparatus from the second temperature sensor,
to acquire an offset value based on the transmission side temperature information, the reception side temperature information, and the data map, and
to execute an amendment to cause the second frequency of the second vibrator to approach the first frequency of the first vibrator by adding the acquired offset value to the second vibrator.

2. A vehicular control system including a portable apparatus carried by a user and an in-vehicle apparatus mounted in a vehicle, for controlling a permission or refusal of a manipulation of the user to the in-vehicle apparatus based on wireless communications of the portable apparatus and the in-vehicle apparatus,
the portable apparatus comprising:
a first vibrator to oscillate on a first frequency;
a first temperature sensor to measure a temperature of the portable apparatus; and
a transmission IC to drive the first vibrator and generate a wireless signal on the first frequency while transmitting the wireless signal containing transmission side temperature information which indicates a temperature of the portable apparatus measured by the first temperature sensor,
the in-vehicle apparatus comprising:
a second vibrator to oscillate on a second frequency;
a second temperature sensor to measure a temperature of the in-vehicle apparatus;
a reception IC to drive the second vibrator to generate a basic signal on the second frequency, operating based on the basic signal while receiving the wireless signal containing the transmission side temperature information; and
an amendment device
to store a data map of a frequency and temperature characteristic with respect to the first vibrator and the second vibrator,
to receive the transmission side temperature information via the reception IC and reception side temperature information which indicates the temperature of the in-vehicle apparatus from the second temperature sensor,
to acquire an offset value based on the transmission side temperature information, the reception side temperature information, and the data map, and
to execute an amendment to cause the second frequency of the second vibrator to approach the first frequency of the first vibrator by adding the acquired offset value to the second vibrator.
